(19) United States
(12) Patent Application Publication
(10) Pub. No.: US 2017/0374331 A1
(43) Pub. Date: Dec. 28, 2017

(54) AUTO KEYSTONE CORRECTION AND AUTO FOCUS ADJUSTMENT

(71) Applicant: Intel Corporation, Santa Clara, CA (US)

(72) Inventors: Tim Liu, New Taipei City (TW); Gerry Juan, Taipei (TW); Simon Tsai, Taoyuan (TW); Jeff Ku, Taipei (TW); Gavin Sung, Taipei (TW)

(21) Appl. No.: 15/193,964

(22) Filed: Jun. 27, 2016

(51) Int. Cl. H04N 9/31

(52) U.S. Cl. CPC H04N 9/3185; H04N 9/3194

(57) ABSTRACT

An apparatus and method for performing automatic keystone correction and automatic focus correction in a system. In one embodiment, the method comprises analyzing an image projected on a projection surface by a projector of a device and captured by one or more cameras of the device to determine whether shape of the image indicates keystone correction is needed and adjusting display output of the projector to cause the display output to be rectangular on the projection surface.

### FIELD OF THE INVENTION

Embodiments of the present invention relate to the field of computing devices with projection devices; more particularly, embodiments of the present invention relate to performing auto focus and auto keystone corrections such computing devices.

### BACKGROUND OF THE INVENTION

Stereo depth cameras are well-known and are often used to measure a distance from an object. One such measurement device includes a projector and a camera. In such a device, the projector projects a known pattern image on an object (e.g., a scene), and an image of the object upon which the image is projected is captured by the camera. From the captured images, depth information may be determined. One technique for determining depth in such devices is through the use of triangulation. Thus, images of objects are captured and measurements are taken to determine depth information.

It is well known that use of an infra-red (IR) laser projector to project a textured pattern onto the target provides a significant boost to the performance of stereoscopic depth cameras. The projected pattern adds texture to the scene and allows high accuracy depth imaging of even targets with minimal or no texture such as a wall. In the case of stereo cameras using structured light approach, the knowledge of the size and distance between the features in the projected pattern is even more important and acts as the main mechanism to achieve accurate depth maps. Due to these reasons, an IR laser pattern projector has been widely used in almost all stereoscopic depth cameras.

One problem with the use of projectors is that it is difficult for users to place the projector in an adequate location and angle with respect to an object surface (e.g., a wall) to get good quality display with the correct focus and a non-skewed rectangular shape. Some modern projectors have keystone correction technology to improve the projector display quality. However, this keystone correction technology requires user's manual adjustment which takes times, is not accurate, and is not user friendly.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a capture system.

FIG. 2 illustrates a flow diagram of one embodiment of a process for automatically focusing an image being displayed by a capture subsystem.

FIG. 3 illustrates a flow diagram of one embodiment of a process for performing keystone corrections for images to be displayed by a capture subsystem.

FIG. 4 illustrates a flow diagram of another embodiment of a process for performing keystone corrections for images to be displayed by a capture subsystem.

FIG. 5 illustrates examples of newly projected images generated after keystone correction being reduced in size to the trapezoid images originally displayed.

FIG. 6 illustrates an example of depth based keystone correction.

FIG. 7 is a flow diagram of one embodiment of a process for performing both auto focus and auto keystone image distortion correction.

FIG. 8 illustrates one embodiment of an example system.

FIG. 9 illustrates an embodiment of a computing environment capable of performing auto focus and keystone correction.

### DETAILED DESCRIPTION OF THE PRESENT INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical, electrical, or optical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

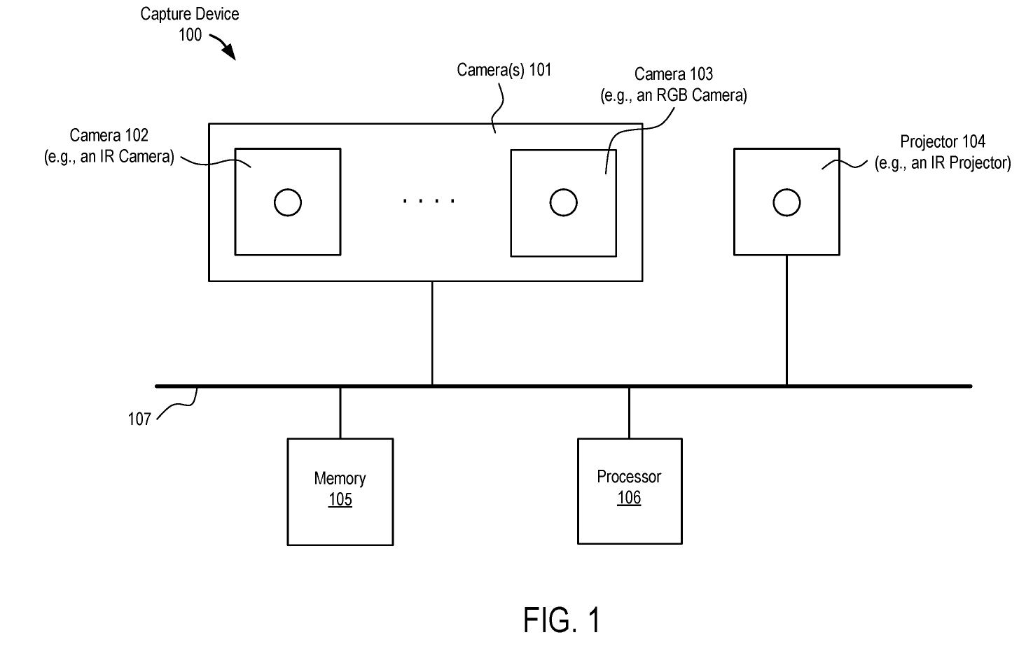

FIG. 1 illustrates one embodiment of a capture system. The capture system may be used as an active coded light triangulation system. The system includes coded light range cameras operating by projecting a sequence of one-dimensional binary (“black” and “white”) patterns onto a scene, such that the produced binary code encodes the angle of the projection plane. Depth is then reconstructed by triangulation consisting of computing the intersection of an imaginary ray emanating from the camera with the plane emanating from the projector.

Referring to FIG. 1, capture device 100 may include a 3D scanner, a 3D camera or any other device configured for a 3D object acquisition. In some embodiments, as illustrated, capture device 100 includes an image capturing device 102 (e.g., a digital camera) and a projector unit 104, such as a laser projector or laser scanner, having a number of components. In some embodiments, digital camera 102 may comprise an infrared (IR) camera, and the projector unit 104 may comprise an IR projector. Note that there may be more than one IR camera in capture device 100.

Projector unit 104 is configured to project a light pattern as described above and may comprise a one-dimensional code projector. In one embodiment, the light patterns comprise one-dimensional coded light patterns, e.g., the patterns that may be described by one-dimensional or linear codes. The light patterns formed by the laser planes on a surface of the object may be received by image capturing device 102 and sensed (e.g., read) by a sensor of image capturing device 102. Based on the readings of the multiple scans of the light patterns accumulated during a sensing cycle of the sensor, capture device 100 may be configured to reconstruct the shape of the object.

In some embodiments, capture device 100 may further include another image capturing device, such as digital camera 103. In some embodiments, digital camera 103 may have a resolution that is different than that of digital camera 103. For example, digital camera 102 may be a multi-chromatic camera, such as red, green, and blue (RGB) camera configured to capture texture images of an object.

Capture device 100 may further include a processor 106 that may be in operative communication with the image camera component 101 over a bus or interconnect 107. Processor 106 may include a standardized processor, a specialized processor, a microprocessor, or the like that may execute instructions that may include instructions for generating depth information, generating a depth image, determining whether a suitable target may be included in the depth image, or performing other operations described herein.

Processor 106 may be configured to reconstruct the object based on the images captured by digital camera 102, for example, using geometry techniques or other techniques used for 3D image reconstruction. Processor 106 may be further configured to dynamically calibrate capture device 100 to correct distortions in the reconstructed image of the object that may be caused, for example, by various external factors (e.g., temperature).

Capture device 100 may further include a memory 105 that may store the instructions that may be executed by processor 106, images or frames of images captured by the cameras, user profiles or any other suitable information, images, or the like. According to one example, memory 105 may include random access memory (RAM), read only memory (ROM), cache, Flash memory, a hard disk, or any other suitable storage component. As shown in FIG. 1, memory component 105 may be a separate component in communication with the cameras 101 and processor 106. Alternatively, memory 105 may be integrated into processor 106 and/or the image capture cameras 101. In one embodiment, some or all of the components 102-106 are located in a single housing.

Processor 105, memory 104, other components (not shown), image capturing device 102, image capturing device 103, and projector unit 104 may be coupled with one or more interfaces (not shown) configured to facilitate information exchange among the above-mentioned components. Communications interface(s) (not shown) may provide an interface for device 100 to communicate over one or more wired or wireless network(s) and/or with any other suitable device. In various embodiments, capture device 100 may be included to or associated with, but is not limited to, a server, a workstation, a desktop computing device, or a mobile computing device (e.g., a laptop computing device, a handheld computing device, a handset, a tablet, a smartphone, a netbook, ultrabook, etc.).

In one embodiment, capture device 100 is integrated into a computer system (e.g., laptop, personal computer (PC), etc.). However, capture device 100 can be alternatively configured as a standalone device that is couplable to such a computer system using conventional technologies including both wired and wireless connections.

In various embodiments, capture device 100 may have more or less components, and/or different architectures. For example, in some embodiments, capture device 100 may include one or more of a camera, a keyboard, display such as a liquid crystal display (LCD) screen (including touch screen displays), a touch screen controller, non-volatile memory port, antenna or multiple antennas, graphics chip, ASIC, speaker(s), a battery, an audio codec, a video codec, a power amplifier, a global positioning system (GPS) device, a compass, an accelerometer, a gyroscope, and the like. In various embodiments, capture device 100 may have more or less components, and/or different architectures. In various embodiments, techniques and configurations described herein may be used in a variety of systems that benefit from the principles described herein.

Capture device 100 may be used for a variety of purposes, including, but not limited to, being part of a target recognition, analysis, and tracking system to recognize human and non-human targets in a capture area of the physical space without the use of special sensing devices attached to the subjects, uniquely identify them, and track them in three-dimensional space. Capture device 100 may be configured to capture video with depth information including a depth image that may include depth values via any suitable technique including, for example, triangulation, time-of-flight, structured light, stereo image, or the like.

Capture device 100 may be configured to operate as a depth camera that may capture a depth image of a scene. The depth image may include a two-dimensional (2D) pixel area of the captured scene where each pixel in the 2D pixel area may represent a depth value such as a distance in, for example, centimeters, millimeters, or the like of an object in the captured scene from the camera. In this example, capture device 100 includes an IR light projector 404, an IR camera 102, and a visible light RGB camera 103 that are configured in an array. In one embodiment, an additional IR camera is included in capture device 100.

Various techniques may be utilized to capture depth video frames. For example, capture device 100 may use structured light to capture depth information. In such an analysis, patterned light (i.e., light displayed as a known pattern such as a grid pattern or a stripe pattern) may be projected onto the capture area via, for example, IR light projector 104. Upon striking the surface of one or more targets or objects in the capture area, the pattern may become deformed in response. Such a deformation of the pattern may be captured by, for example, he IR camera 102 and/or the RGB camera 103 and may then be analyzed to determine a physical distance from capture device 100 to a particular location on the targets or objects.

Capture device 100 may utilize two or more physically separated cameras that may view a capture area from different angles, to obtain visual stereo data that may be resolved to generate depth information. Other types of depth image arrangements using single or multiple cameras can also be used to create a depth image.

Capture device 100 may provide the depth information and images captured by, for example, IR camera 102 and/or the RGB camera 103, including a skeletal model and/or facial tracking model that may be generated by capture device 100, where the skeletal and/or facial tracking models, depth information, and captured images are used to, for example, create a virtual screen, adapt the user interface, and control an application.

In summary, capture device 100 may comprise a projector unit 104 (e.g., an IR projector), a digital camera (e.g., IR camera) 102, another digital camera (e.g., multi-chromatic camera) 103, and a processor (controller) configured to operate capture device 100 according to the embodiments described herein. However, the above assembly configuration is described for illustration purposes only, and is should not be limiting to the present disclosure. Various configurations of an assembly for a 3D object acquisition may be used to implement the embodiments described herein. For example, an assembly for a 3D object acquisition configured to enable the reconstructed object distortion corrections may include three digital cameras, two of which may be used to reconstruct a 3D image of an object, and the third camera (e.g. with a resolution that is different than those of the two cameras) may be used to capture images of the object in order to identify image distortions in the reconstructed object and to compensate for identified distortions.

### Auto Focus and Auto Keystone Correction

As discussed above, a coded light camera comprising an IR projector 104 projects one-dimensional code patterns onto the scene, and one or more of IR camera 102 captures the patterns. Decoding of the captured patterns at every pixel location xc in the camera produces a code encoding the location xp of the projected plane. In triangulation, the plane is intersected with the ray emanating from the camera focal point through xc, yielding the distance to the object z(xc).

In one embodiment, a processing unit receives a sequence of images and reconstructs depth using triangulation in response to camera and projector location coordinates. In one embodiment, the processing unit is operable to generate a depth value based on the new projector location coordinate a camera location coordinate.

In one embodiment, once the measurements including depth information corresponding to the depth from the capture device to the projection surface has been obtained, the capture device uses this information to precisely adjust the motor in optical engine to accomplish autofocus. Also, in one embodiment, the capture device captures images of the display created by the projector of the capture device. These images may indicate the projector is producing a skewed (trapezoid) display. The images are analyzed and then adjustments are made to the digital video output of the capture device accordingly to complete auto vision or depth based horizontal/vertical keystone corrections. In one embodiment, this analysis is performed by software on the capture device.

In one embodiment, the auto focus and auto keystone correction are accomplished via a three-dimensional (3D) camera automatically without user inputs, which greatly improves the user experience of projected computing.

### Auto Focus

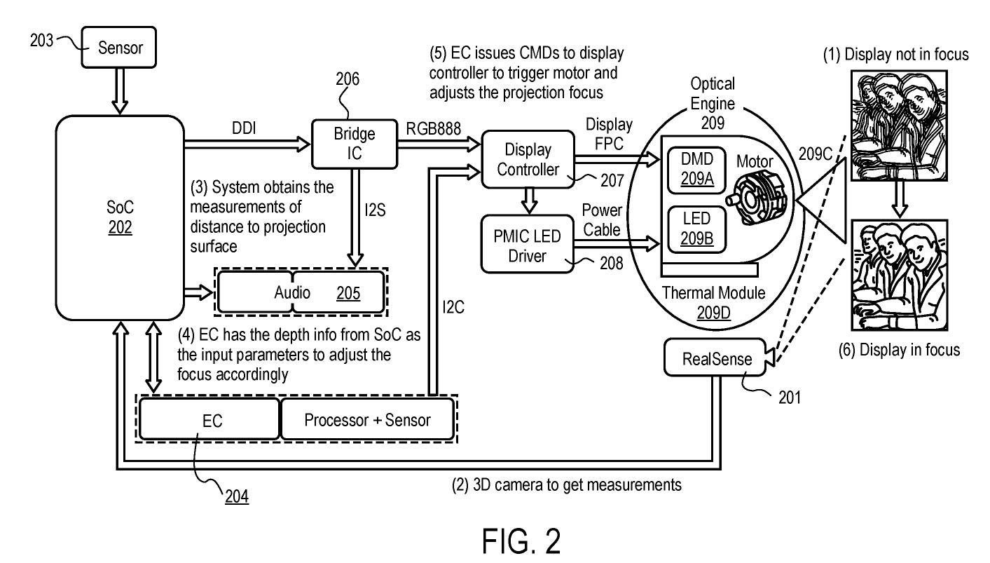

FIG. 2 illustrates a flow diagram of one embodiment of a process for automatically focusing an image being displayed by a capture subsystem. In one embodiment, a processing device, such as a system-on-a-chip (SoC) executing a software application and an embedded controller (EC) executing firmware, receives measurements from the capture subsystem and manipulates the motor adjustment in an optical engine to achieve autofocus.

Referring to FIG. 2, a capture subsystem 201 comprises a projector, one or more IR cameras and a color (e.g., Red-Green-Blue (RGB)) camera, such as shown, for example, in FIG. 1. In one embodiment, capture subsystem 201 is a 3D capture system.

Capture subsystem 201 is coupled to SoC 202. While an SoC is shown in FIG. 2, in alternative embodiments, SoC 202 is replaced with a processor (e.g., a multicore processor), central processing unit, microcontroller, projector display controller, or another type of processing device. SoC 202 is coupled to sensor 203, EC 204, audio device 205 and bridge integrated circuit (IC) 206. In one embodiment, EC 204 comprises a processor and a sensor.

In one embodiment, SoC 202 is coupled to bridge IC 206 via a device driver interface (DDI). Audio device 205 performs audio operations and is also coupled to bridge IC 206. In one embodiment, audio device 205 is coupled to bridge IC 206 via an I2S bus. Both bridge IC 206 and EC 204 are coupled to display controller 207. In one embodiment, bridge IC 206 and EC 204 are coupled to display controller 207 via a camera interface (e.g., a RGB888 interface) and an I2C bus, respectively. Display controller 207 is coupled a power management IC (PMIC) light emitting diode (LED) driver 208 and optical engine 209. In one embodiment, display controller 207 is coupled to optical engine 209 via a display Frame Buffer Object (FBO) interface. PMIC LED driver 208 is also coupled to optical engine 209 to drive LED 209B therein.

Optical engine 309 includes a digital mirror (DMD) 209A, LEDs 209B, a motor 209C and a thermal module 209D for thermal control. Though optical engine 209 is shown separate from capture subsystem 201, in one embodiment, it is part of capture subsystem 201.

In one embodiment, after displaying an image that is not in focus, to perform autofocus, capture subsystem 201 captures images and sends them to SoC 202 for processing. In response to the captured images, SoC obtains the measurements of the distance to the projection surface. In one embodiment, the measurements relate to depth information, which may be determined as described above, and may include color information (e.g., raw RGB data). EC 204 receives the depth information from SoC 202 as input parameters to adjust the focus. In response to the input parameters, EC 204 sends commands to display controller 207 to trigger motor movements of the optical engine 209 and adjusts the projection focus.

Thus, the system performs auto focus using depth information from a capture subsystem.

### Auto Keystone Correction

Techniques are disclosed herein to perform auto keystone correction. In one embodiment, the auto keystone correction is an image-based (vision-based) correction technique. In another embodiment, the auto keystone correction is a depth-based correction technique. In one embodiment, the system analyzes the RGB image raw data and depth information and identifies whether keystone corrections are needed. If corrections are needed, a processing device (e.g., SoC, a projector display controller, etc.) reforms the display output to restore the output image data into a rectangular display.

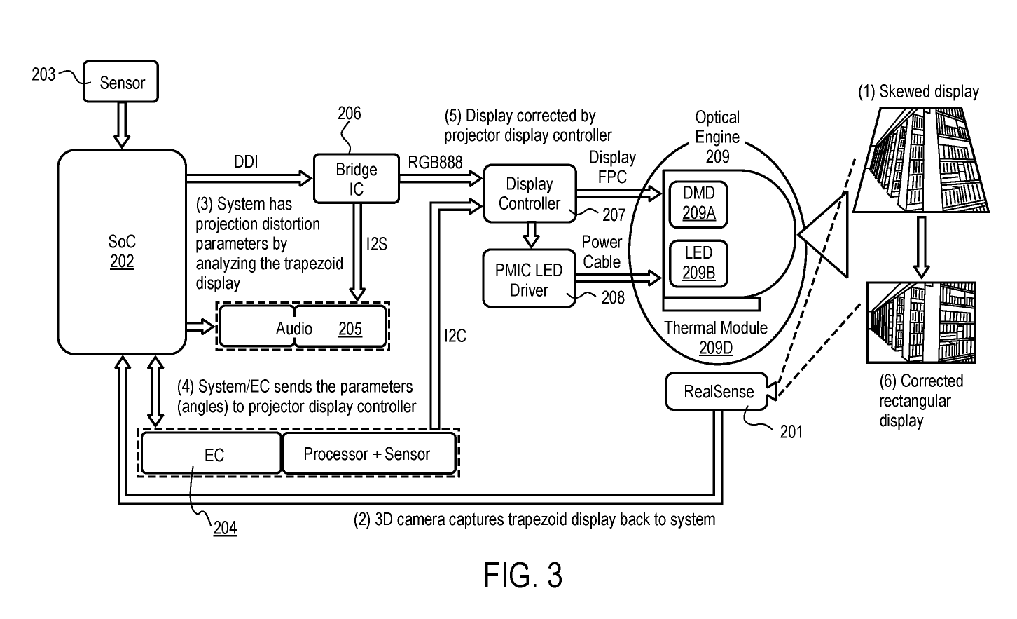

In one embodiment, the system depicted in FIG. 2 performs keystone correction. FIG. 3 illustrates an example of the system of FIG. 2 performing keystone correction. Referring to FIG. 3, capture subsystem 201 captures a skewed trapezoid image (1) being displayed by the projector of capture subsystem 201 and sends it back to SoC 202 (2). SoC 202 analyzes the trapezoid image data received from capture subsystem 201 and obtains projection distortion parameters in response thereto (3). In one embodiment, the projection distortion parameters include the angles between each direction to the left and right edges of the image and a line from the projector perpendicular to the image surface. SoC 202, or alternatively EC 204, sends the projection distortion parameters to projector display controller 207 (4), which uses the projection distortion parameters to correct the projector output so that it is rectangular in shape (5), so that a corrected rectangular display on the projection surface is displayed (6). Thus, the SoC (e.g., an application being run by the SoC) analyze the trapezoid image being displayed and outputs the parameters for display correction done by the projector display controller.

In another embodiment, the system depicted in FIG. 2 performs keystone correction. FIG. 3 illustrates an example of the system of FIG. 2 performing keystone correction. Referring to FIG. 3, capture subsystem 201 captures a skewed trapezoid image (1) being displayed by the projector of capture subsystem 201 and sends it back to SoC 202 (2). SoC 202 analyzes the trapezoid image data received from capture subsystem 201 and obtains projection distortion parameters in response thereto (3). In one embodiment, the projection distortion parameters include the angles between each direction to the left and right edges of the image and a line from the projector perpendicular to the image surface. SoC 202, or alternatively EC 204, sends the projection distortion parameters (e.g., angles) to projector display controller 207 (4), which uses the projection distortion parameters to correct the projector output so that it is rectangular in shape (5), so that a corrected rectangular display on the projection surface is displayed (6). Thus, the SoC (e.g., an application being run by the SoC) analyzes the trapezoid image being displayed and outputs the parameters for display correction done by the projector display controller.

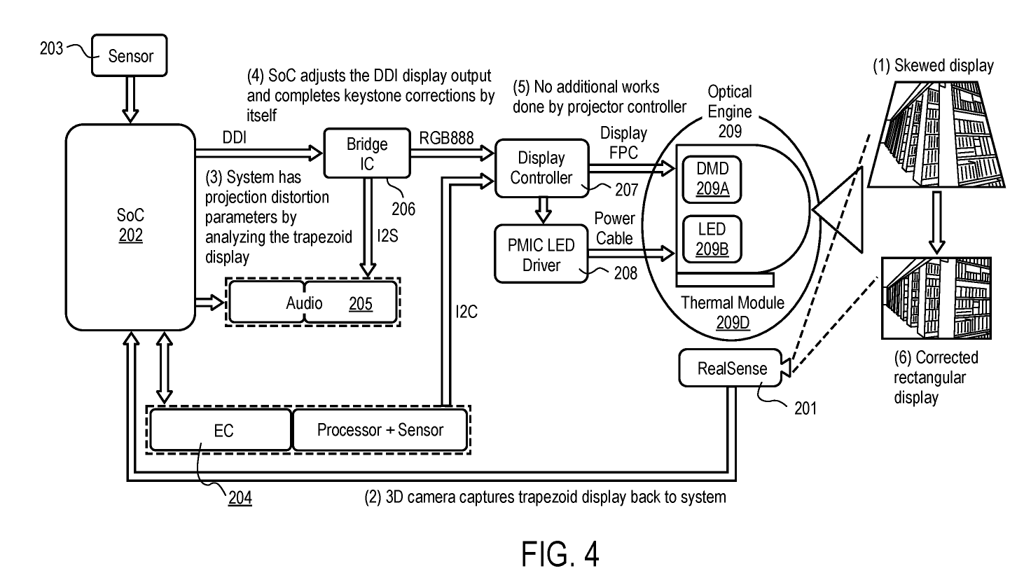

FIG. 4 illustrates another example of the system of FIG. 2 performing an alternative embodiment of keystone correction. Referring to FIG. 4, capture subsystem 201 captures a skewed trapezoid image (1) being displayed by the projector of capture subsystem 201 (2) and sends it back to SoC 202 (2). SoC 202 analyzes the trapezoid image data received from capture subsystem 201 and obtains projection distortion parameters in response thereto (3). In one embodiment, the projection distortion parameters include the angles between each direction to the left and right edges of the image and a line from the projector perpendicular to the image surface. SoC 202 adjusts the DDI display output and completes the keystone corrections (4). The corrected data is then sent to projector display controller 207, via bridge IC 206, which doesn't have to perform anything further for the keystone correction (5), and a corrected rectangular display on the projection surface is displayed (6). Thus, the SoC (e.g., an application being run by the SoC) analyzes the trapezoid image being displayed and perform the keystone correction itself.

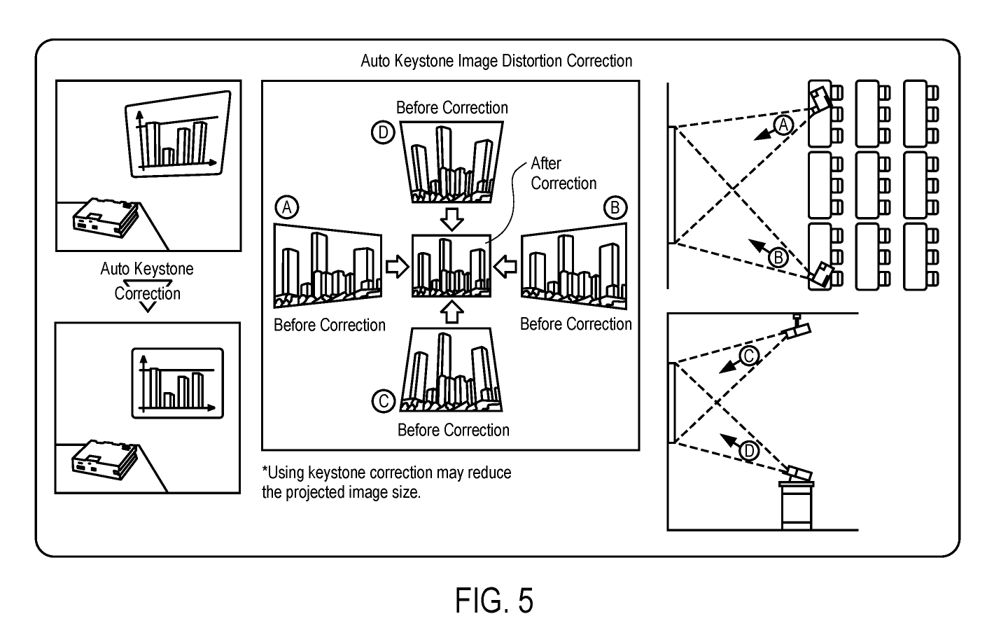

Note that when applying digital keystone correction to an image, the number of individual pixels used is reduced, thereby lowering the resolution and thus degrading the quality of the image being projected. FIG. 5 illustrates this effect. Referring to FIG. 5, three examples are provided to illustrate a newly projected image after keystone correction is reduced in size.

### Depth Based Keystone Correction

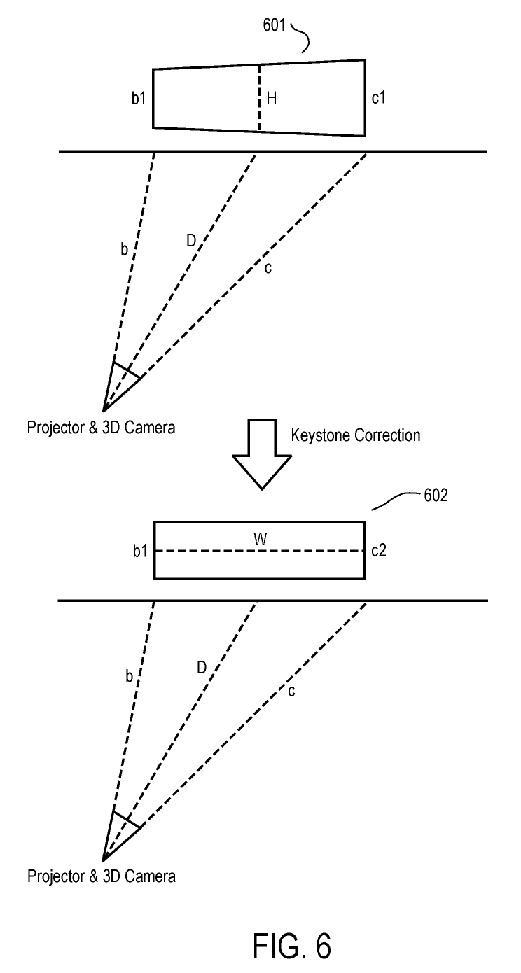

FIG. 6 illustrates an example of depth based keystone correction. Referring to FIG. 6, a capture device (e.g., the capture device of FIG. 1) includes a projector and 3D camera and projects trapezoid image 601 onto a surface (e.g., a wall). The left side of image 601 has height b1, while the right side of image 601 has height c1, which is larger than height b1. The distance from the projector/3D camera to the surface where the left side of image 601 appears is distance b, the distance from the projector/3D camera to the surface where the right side of image 601 appears is distance c, and the distance from the projector/3D camera to the surface where the center of image 601 appears is distance D. The center of image 601 has height H. In one embodiment, a depth based keystone correction is performed using the following:

$$Tr ( throw ratio ) = \frac{D}{W} = \frac{D}{H} = \frac{b 1}{b} = \frac{c 1}{c}$$

If b=c, no keystone correction needed

If b<c, keystone correction needed

$$c 2 = c 1 * \frac{b 1}{c 1} = c 1 * \frac{b}{c}$$

If b>c, keystone correction needed

$$b 2 = b 1 * \frac{c 1}{b 1} = b 1 * \frac{c}{b}$$

where b2 and c2 correlate to the new sizes of the left and right sides of the projected image 602 after keystone correction.

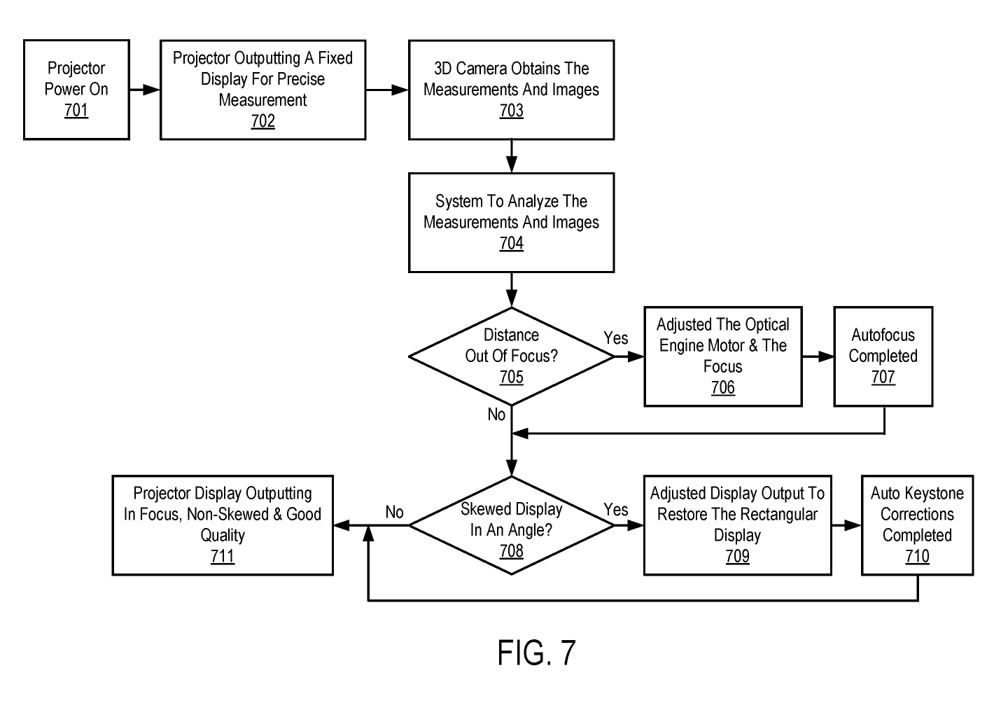

FIG. 7 is a flow diagram of one embodiment of a process for performing both auto focus and auto keystone image distortion correction. The process is performed by processing logic that may comprise hardware (circuitry, dedicated logic, etc.), software (such as is run on a general purpose computer system or a dedicated machine), firmware, or a combination of the three. In one embodiment, the process is performed by the device described in FIGS. 2-4.

Referring to FIG. 7, the process begins with processing logic in the system triggering the projector to power on (processing block 701). In one embodiment, this occurs in response to a user request.

Once powered on, in one embodiment, processing logic in the system, using its projector, outputs a fixed calibration display for a number of seconds, in order to have more precise measurements by the 3D camera of the system (processing block 702).

Processing logic in conjunction with the 3D camera, obtains measurements, such as, for example, depth and RGB raw data, from the projection surface (processing block 703) and analyzes the measurements and image data (processing block 704).

Next, processing logic in the system determines whether the distance between the projector and the projection surface is such that the projected image is out of focus (processing block 705). If the projected image is not out of focus, processing logic transitions to processing block 708. If the projected image is out of focus, the process transitions to processing block 706 where processing logic in the system adjusts the motor in the optical engine, if needed, to have display in focus according to the measured distance (e.g., the depth information). In one embodiment, if the depth information indicates that the actual depth between the projector and the project surface is not equal to the distance used to focus the previously projected image from the projector, then the processing logic determines the projected image is out of focus. Alternatively, other methods such as phase detection or contrast detection could be used to determine the projected image is out of focus, which is well-known to those skilled in the art. Once the motor adjustments have been made, the auto focus is completed (processing block 707) and the process transitions to processing block 708.

At processing block 708, processing logic determines whether the projected display is skewed in any angle. If not, the process transitions to processing block 711 where processing logic in the system concludes that the projector display being output is in focus, non-skewed and is good quality. If the projected image being displayed is skewed, the process transitions to processing block 709 where processing logic adjusts the display output to restore the displayed image to a rectangular shape. Thereafter, the keystone correction is completed (processing block 710) and the process transitions to processing block 711.

In one embodiment, all operations in FIG. 7 are performed automatically without user inputs.

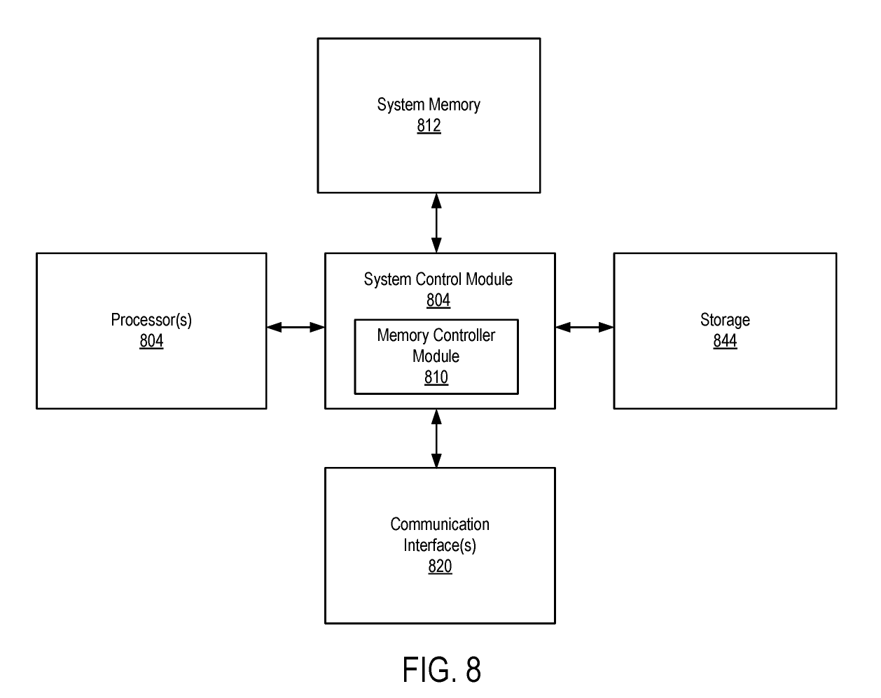

FIG. 8 illustrates, for one embodiment, an example system 800 having one or more processor(s) 804, system control module 808 coupled to at least one of the processor(s) 804, system memory 812 coupled to system control module 808, non-volatile memory (NVM)/storage 814 coupled to system control module 808, and one or more communications interface(s) 820 coupled to system control module 808. In some embodiments, the system 800 may include capture device 100 and provide logic/module that performs functions aimed at compensating for projector distortions in the depth determination in a reconstructed object image described herein.

In some embodiments, the system 800 may include one or more computer-readable media (e.g., system memory or NVM/storage 814) having instructions and one or more processors (e.g., processor(s) 804) coupled with the one or more computer-readable media and configured to execute the instructions to implement a module to perform image distortion correction calculation actions described herein.

System control module 808 for one embodiment may include any suitable interface controllers to provide for any suitable interface to at least one of the processor(s) 804 and/or to any suitable device or component in communication with system control module 808.

System control module 808 may include memory controller module 810 to provide an interface to system memory 812. The memory controller module 810 may be a hardware module, a software module, and/or a firmware module. System memory 812 may be used to load and store data and/or instructions, for example, for system 800. System memory 812 for one embodiment may include any suitable volatile memory, such as suitable DRAM, for example. System control module 808 for one embodiment may include one or more input/output (I/O) controller(s) to provide an interface to NVM/storage 814 and communications interface(s) 820.

The NVM/storage 814 may be used to store data and/or instructions, for example. NVM/storage 814 may include any suitable non-volatile memory, such as flash memory, for example, and/or may include any suitable non-volatile storage device(s), such as one or more hard disk drive(s) (HDD(s)), one or more compact disc (CD) drive(s), and/or one or more digital versatile disc (DVD) drive(s), for example. The NVM/storage 814 may include a storage resource physically part of a device on which the system 800 is installed or it may be accessible by, but not necessarily a part of, the device. For example, the NVM/storage 814 may be accessed over a network via the communications interface(s) 820.

Communications interface(s) 820 may provide an interface for system 800 to communicate over one or more network(s) and/or with any other suitable device. The system 800 may wirelessly communicate with the one or more components of the wireless network in accordance with any of one or more wireless network standards and/or protocols.

For one embodiment, at least one of the processor(s) 804 may be packaged together with logic for one or more controller(s) of system control module 808, e.g., memory controller module 810. For one embodiment, at least one of the processor(s) 804 may be packaged together with logic for one or more controllers of system control module 808 to form a System in Package (SiP). For one embodiment, at least one of the processor(s) 804 may be integrated on the same die with logic for one or more controller(s) of system control module 808. For one embodiment, at least one of the processor(s) 804 may be integrated on the same die with logic for one or more controller(s) of system control module 808 to form a System on Chip (SoC).

In various embodiments, the system 800 may have more or less components, and/or different architectures. For example, in some embodiments, the system 800 may include one or more of a camera, a keyboard, liquid crystal display (LCD) screen (including touch screen displays), non-volatile memory port, multiple antennas, graphics chip, application-specific integrated circuit (ASIC), and speakers.

In various implementations, the system 800 may be, but is not limited to, a mobile computing device (e.g., a laptop computing device, a handheld computing device, a tablet, a netbook, etc.), a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the system 800 may be any other electronic device.

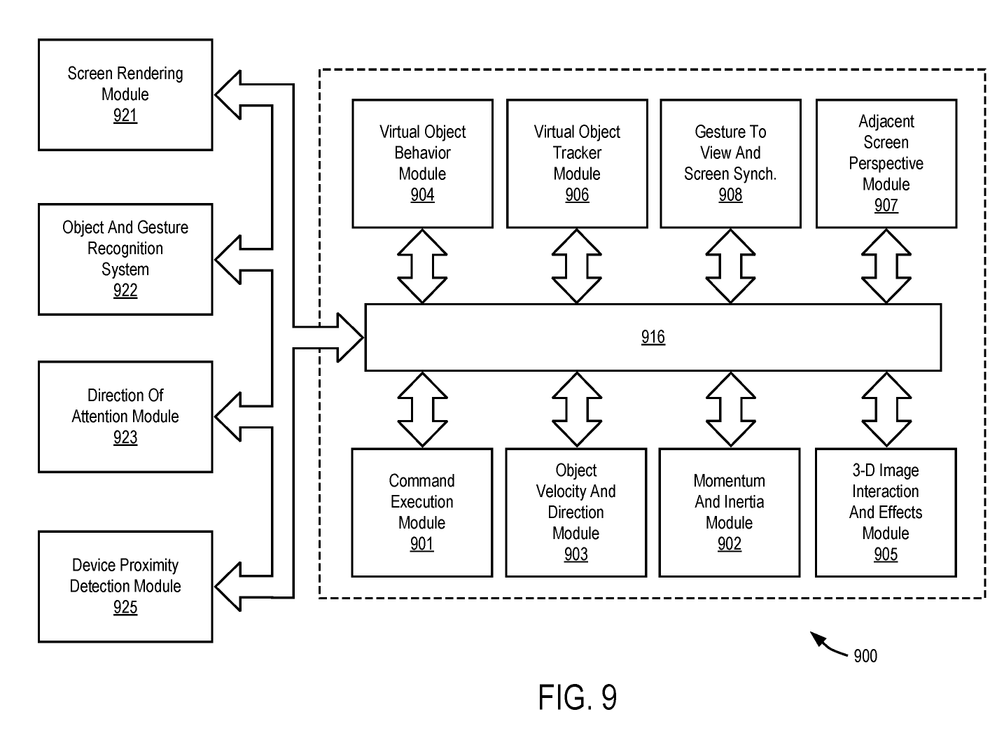

FIG. 9 illustrates an embodiment of a computing environment 900 capable of supporting the operations discussed above. The modules described before can use the depth information (e.g., values) and other data described above to perform these functions. The modules and systems can be implemented in a variety of different hardware architectures and form factors.

Command Execution Module 901 includes a central processing unit to cache and execute commands and to distribute tasks among the other modules and systems shown. It may include an instruction stack, a cache memory to store intermediate and final results, and mass memory to store applications and operating systems. Command Execution Module 901 may also serve as a central coordination and task allocation unit for the system.

Screen Rendering Module 921 draws objects on the one or more multiple screens for the user to see. It can be adapted to receive the data from Virtual Object Behavior Module 904, described below, and to render the virtual object and any other objects and forces on the appropriate screen or screens. Thus, the data from Virtual Object Behavior Module 904 would determine the position and dynamics of the virtual object and associated gestures, forces and objects, for example, and Screen Rendering Module 921 would depict the virtual object and associated objects and environment on a screen, accordingly. Screen Rendering Module 921 could further be adapted to receive data from Adjacent Screen Perspective Module 907, described below, to either depict a target landing area for the virtual object if the virtual object could be moved to the display of the device with which Adjacent Screen Perspective Module 907 is associated. Thus, for example, if the virtual object is being moved from a main screen to an auxiliary screen, Adjacent Screen Perspective Module 907 could send data to the Screen Rendering Module 921 to suggest, for example in shadow form, one or more target landing areas for the virtual object on that track to a user's hand movements or eye movements.

Object and Gesture Recognition System 922 may be adapted to recognize and track hand and harm gestures of a user. Such a module may be used to recognize hands, fingers, finger gestures, hand movements and a location of hands relative to displays. For example, Object and Gesture Recognition System 922 could for example determine that a user made a body part gesture to drop or throw a virtual object onto one or the other of the multiple screens, or that the user made a body part gesture to move the virtual object to a bezel of one or the other of the multiple screens. Object and Gesture Recognition System 922 may be coupled to a camera or camera array, a microphone or microphone array, a touch screen or touch surface, or a pointing device, or some combination of these items, to detect gestures and commands from the user.

The touch screen or touch surface of Object and Gesture Recognition System 922 may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by Object and Gesture Recognition System 922, using one or more cameras, without the benefit of a touch surface.

Direction of Attention Module 923 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to Object and Gesture Recognition Module 922 to ensure that the gestures or commands are associated with the appropriate library for the active display. Similarly, if the user is looking away from all of the screens, then commands can be ignored.

Device Proximity Detection Module 925 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to Object Gesture and Recognition System 922. For a display device, it may be considered by Adjacent Screen Perspective Module 907.

Virtual Object Behavior Module 904 is adapted to receive input from Object Velocity and Direction Module 903, and to apply such input to a virtual object being shown in the display. Thus, for example, Object and Gesture Recognition System 922 would interpret a user gesture and by mapping the captured movements of a user's hand to recognized movements, Virtual Object Tracker Module 906 would associate the virtual object's position and movements to the movements as recognized by Object and Gesture Recognition System 922, Object and Velocity and Direction Module 903 would capture the dynamics of the virtual object's movements, and Virtual Object Behavior Module 904 would receive the input from Object and Velocity and Direction Module 903 to generate data that would direct the movements of the virtual object to correspond to the input from Object and Velocity and Direction Module 903.

Virtual Object Tracker Module 906 on the other hand may be adapted to track where a virtual object should be located in three-dimensional space in a vicinity of a display, and which body part of the user is holding the virtual object, based on input from Object Gesture and Recognition System 922. Virtual Object Tracker Module 906 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

Gesture to View and Screen Synchronization Module 908, receives the selection of the view and screen or both from Direction of Attention Module 923 and, in some cases, voice commands to determine which view is the active view and which screen is the active screen. It then causes the relevant gesture library to be loaded for Object and Gesture Recognition System 922. Various views of an application on one or more screens can be associated with alternative gesture libraries or a set of gesture templates for a given view.

Adjacent Screen Perspective Module 907, which may include or be coupled to Device Proximity Detection Module 925, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. Adjacent Screen Perspective Module 907 may, in this way, determine coordinates of an adjacent screen relative to its own screen coordinates. Thus, the Adjacent Screen Perspective Module may determine which devices are in proximity to each other, and further potential targets for moving one or more virtual object's across screens. Adjacent Screen Perspective Module 907 may further allow the position of the screens to be correlated to a model of three-dimensional space representing all of the existing objects and virtual objects.

Object and Velocity and Direction Module 903 may be adapted to estimate the dynamics of a virtual object being moved, such as its trajectory, velocity (whether linear or angular), momentum (whether linear or angular), etc. by receiving input from Virtual Object Tracker Module 906. The Object and Velocity and Direction Module 903 may further be adapted to estimate dynamics of any physics forces, by for example estimating the acceleration, deflection, degree of stretching of a virtual binding, etc. and the dynamic behavior of a virtual object once released by a user's body part. Object and Velocity and Direction Module 903 may also use image motion, size and angle changes to estimate the velocity of objects, such as the velocity of hands and fingers

Momentum and Inertia Module 902 can use image motion, image size, and angle changes of objects in the image plane or in a three-dimensional space to estimate the velocity and direction of objects in the space or on a display. Momentum and Inertia Module 902 is coupled to Object and Gesture Recognition System 922 to estimate the velocity of gestures performed by hands, fingers, and other body parts and then to apply those estimates to determine momentum and velocities to virtual objects that are to be affected by the gesture.

3D Image Interaction and Effects Module 905 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module 905 in the foreground on one or more of the displays.

In a first example embodiment, a method comprises analyzing an image projected on a projection surface by a projector of a device and captured by one or more cameras of the device to determine whether shape of the image indicates keystone correction is needed and adjusting display output of the projector to cause the display output to be rectangular on the projection surface.

In another example embodiment, the subject matter of the first example embodiment can optionally include generating projection distortion parameters in response to analyzing the image.

In another example embodiment, the subject matter of the first example embodiment can optionally include sending the projection distortion parameters to a display controller of the projector and correcting, by the projector display controller, the display output of the projector.

In another example embodiment, the subject matter of the first example embodiment can optionally include adjusting the display output to be rectangular prior to sending the display output to a display controller of the projector and sending keystone corrected display output to the projector display controller for projection on the projection surface by the projector.

In another example embodiment, the subject matter of the first example embodiment can optionally include determining whether an image projected by a projector of a device is out of focus and adjusting focus of the projector output based on depth information obtained from images captured from one or more cameras of the device. In another example embodiment, the subject matter of this example embodiment can optionally include that adjusting the focus of the image comprises adjusting a motor of an optical engine of the projector to adjust the focus of the projector.

In a second example embodiment, a system comprises: a projector; one or more cameras; and a processor coupled to the projector and the one or more cameras and operable to analyze an image projected on a projection surface by a projector of a device and captured by one or more cameras of the device to determine whether shape of the image indicates keystone correction is needed and adjust display output of the projector to cause the display output to be rectangular on the projection surface.

In another example embodiment, the subject matter of the second example embodiment can optionally include that the processor is operable to generate projection distortion parameters in response to analyzing the image. In another example embodiment, the subject matter of this example embodiment can optionally include a projector display controller coupled to the projector and the processor, wherein the processor is operable to send the projection distortion parameters to a display controller of the projector and the projector display controller is operable to correct the display output of the projector based on the projection distortion parameters. In another example embodiment, the subject matter of that example embodiment can optionally include a projector display controller coupled to the projector and the processor, wherein the processor is operable to adjust the display output to be rectangular prior to sending the display output to a display controller of the projector and send keystone corrected display output to the projector display controller for projection on the projection surface by the projector.

In another example embodiment, the subject matter of the second example embodiment can optionally include that the processor is operable to determine whether an image projected by the projector is out of focus and to adjust focus of the projector output based on depth information obtained from images captured from the one or more cameras of the device. In another example embodiment, the subject matter of the second example embodiment can optionally include that the projector comprises an optical engine, and further comprising a display controller coupled to the projector and the processing device, wherein the processor is operable to adjust the focus of the image by adjusting a motor of the optical engine of the projector to adjust the focus of the projector by sending commands to the display controller.

In a third example embodiment, an article of manufacture has one or more non-transitory computer readable storage media storing instructions which when executed by a system to perform a method comprising analyzing an image projected on a projection surface by a projector of a device and captured by one or more cameras of the device to determine whether shape of the image indicates keystone correction is needed and adjusting display output of the projector to cause the display output to be rectangular on the projection surface.

In another example embodiment, the subject matter of the third example embodiment can optionally include that the method further comprises generating projection distortion parameters in response to analyzing the image. In another example embodiment, the subject matter of this example embodiment can optionally include that the method further comprises sending the projection distortion parameters to a display controller of the projector and correcting, by the projector display controller, the display output of the projector.

In another example embodiment, the subject matter of the third example embodiment can optionally include that the method further comprises adjusting the display output to be rectangular prior to sending the display output to a display controller of the projector and sending keystone corrected display output to the projector display controller for projection on the projection surface by the projector.

In a fourth example embodiment, a method comprises determining whether an image projected by a projector of a device is out of focus and adjusting focus of the projector output based on depth information obtained from images captured from one or more cameras of the device.

In another example embodiment, the subject matter of the fourth example embodiment can optionally include that adjusting the focus of the image comprises adjusting a motor of an optical engine of the projector to adjust the focus of the projector.

In another example embodiment, the subject matter of the fourth example embodiment can optionally include capturing image data with the one or more cameras, the image data being of the image projected on a projection surface from the projector and obtaining measurements of a distance to the projection surface based on analysis of the image data.

In a fifth example embodiment, a system comprises a projector, one or more cameras, and a processor coupled to the projector and operable to determine whether an image projected by the projector is out of focus and to adjust focus of the projector output based on depth information obtained from images captured from the one or more cameras of the device.

In another example embodiment, the subject matter of the fifth example embodiment can optionally include that the projector comprises an optical engine, and further comprising a display controller coupled to the projector and the processing device, wherein the processor is operable to adjust the focus of the image by adjusting a motor of the optical engine of the projector to adjust the focus of the projector by sending commands to the display controller.

In another example embodiment, the subject matter of the fifth example embodiment can optionally include that the one or more cameras are operable to capture image data, the image data being of the image projected on a projection surface from the projector, and further wherein the processor is operable to obtain measurements of a distance to the projection surface based on analysis of the image data.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

1. A method comprising:
analyzing an image projected on a projection surface by a projector of a device and captured by one or more cameras of the device to determine whether shape of the image indicates keystone correction is needed, wherein analyzing the image comprises generating parameters from the image captured by the one or more cameras; and
adjusting display output of the projector based on the parameters generated from the image to cause the display output to be rectangular on the projection surface.

2. The method defined in claim 1 further comprising generating projection distortion parameters in response to analyzing the image.

3. The method defined in claim 2 further comprising:
sending the projection distortion parameters to a display controller of the projector; and
correcting, by the projector display controller, the display output of the projector.

4. The method defined in claim 2 further comprising:
adjusting the display output to be rectangular prior to sending the display output to a display controller of the projector; and
sending keystone corrected display output to the projector display controller for projection on the projection surface by the projector.

5. The method defined in claim 1 further comprising:
determining whether an image projected by a projector of a device is out of focus; and
adjusting focus of the projector output based on depth information obtained from images captured from one or more cameras of the device.

6. The method defined in claim 5 wherein adjusting the focus of the image comprises adjusting a motor of an optical engine of the projector to adjust the focus of the projector.

7. A system comprising:
a projector;
one or more cameras; and
a processor coupled to the projector and the one or more cameras and operable to analyze an image projected on a projection surface by a projector of a device and captured by one or more cameras of the device to determine whether shape of the image indicates keystone correction is needed, generate parameters from the image captured by the one or more cameras, and adjust display output of the projector based on the parameters generated from the image captured by the one or more cameras to cause the display output to be rectangular on the projection surface.

8. The system defined in claim 7 wherein the processor is operable to generate projection distortion parameters in response to analyzing the image.

9. The system defined in claim 8 further comprising a projector display controller coupled to the projector and the processor, wherein the processor is operable to send the projection distortion parameters to a display controller of the projector and the projector display controller is operable to correct the display output of the projector based on the projection distortion parameters.

10. The system defined in claim 8 further comprising a projector display controller coupled to the projector and the processor, wherein the processor is operable to adjust the display output to be rectangular prior to sending the display output to a display controller of the projector and send keystone corrected display output to the projector display controller for projection on the projection surface by the projector.

11. The system defined in claim 7 wherein the processor is operable to determine whether an image projected by the projector is out of focus and to adjust focus of the projector output based on depth information obtained from images captured from the one or more cameras of the device.

12. The system defined in claim 11 wherein the projector comprises an optical engine, and further comprising a display controller coupled to the projector and the processing device, wherein the processor is operable to adjust the focus of the image by adjusting a motor of the optical engine of the projector to adjust the focus of the projector by sending commands to the display controller.

13. An article of manufacture having one or more non-transitory computer readable storage media storing instructions which when executed by a system to perform a method comprising:
analyzing an image projected on a projection surface by a projector of a device and captured by one or more cameras of the device to determine whether shape of the image indicates keystone correction is needed, wherein analyzing the image comprises generating parameters from the image captured by the one or more cameras; and
adjusting display output of the projector based on the parameters generated from the image to cause the display output to be rectangular on the projection surface.

14. The article of manufacture defined in claim 13 wherein the method further comprises generating projection distortion parameters in response to analyzing the image.

15. The article of manufacture defined in claim 14 wherein the method further comprises:
sending the projection distortion parameters to a display controller of the projector; and
correcting, by the projector display controller, the display output of the projector.

16. The article of manufacture defined in claim 14 wherein the method further comprises:
adjusting the display output to be rectangular prior to sending the display output to a display controller of the projector; and
sending keystone corrected display output to the projector display controller for projection on the projection surface by the projector.

17. A method comprising:
determining whether an image projected by a projector of a device is out of focus;
adjusting focus of the projector output based on depth information obtained from images captured from one or more cameras of the device; and
performing keystone correction on the images captured from the one or more cameras by generating parameters from each image captured by the one or more cameras and adjusting display output of the projector based on the parameters to cause the display output to be rectangular on a projection surface.

18. The method defined in claim 17 wherein adjusting the focus of the image comprises adjusting a motor of an optical engine of the projector to adjust the focus of the projector.

19. The method defined in claim 17 further comprising:
capturing image data with the one or more cameras, the image data being of the image projected on a projection surface from the projector; and
obtaining measurements of a distance to the projection surface based on analysis of the image data.

20. A system comprising:
a projector;
one or more cameras; and
a processor coupled to the projector and operable to determine whether an image projected by the projector is out of focus and to adjust focus of the projector output based on depth information obtained from images captured from the one or more cameras of the device and to perform keystone correction on an image captured from the one or more cameras by generating parameters from the image captured by the one or more cameras and adjusting display output of the projector based on the parameters to cause the display output to be rectangular on a projection surface.

21. The system defined in claim 20 wherein the projector comprises an optical engine, and further comprising a display controller coupled to the projector and the processing device, wherein the processor is operable to adjust the focus of the image by adjusting a motor of the optical engine of the projector to adjust the focus of the projector by sending commands to the display controller.

22. The system defined in claim 20 wherein the one or more cameras are operable to capture image data, the image data being of the image projected on a projection surface from the projector, and further wherein the processor is operable to obtain measurements of a distance to the projection surface based on analysis of the image data.
